(19) United States
(12) Patent Application Publication
(10) Pub. No.: US 2003/0176524 A1
(43) Pub. Date: Sep. 18, 2003

(54) Coating having graffiti resistance

(76) Inventor: Robert S. Swingle, Hockessin, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/349,864

(22) Filed: Jan. 23, 2003

Related U.S. Application Data
(60) Provisional application No. 60/351,014, filed on Jan. 23, 2002.

(51) Int. Cl. C08G 2/00

(52) U.S. Cl. 522/91

(57) ABSTRACT

This invention relates to coating materials useful for imparting graffiti resistance to structures.

### FIELD OF THE INVENTION

This invention relates to coating materials useful for coating civil structures where resistance to graffiti is important. It also relates to a method of treating structures such as buildings.

### TECHNICAL BACKGROUND

Various methods of protecting old buildings are known. Fluoropolyethers are used for such protection in the following patents: U.S. Pat. Nos. 4,499,146; 4,745,009; 4,746,550 and 4,902,538.

Carbon dioxide has been used as a solvent for some fluoropolymers and has been used in certain coatings. U.S. Pat. No. 4,023,720 describes supercritical fluids such as carbon dioxide as a diluent for applying certain coatings.

### SUMMARY OF THE INVENTION

Disclosed herein is a resin consisting of a 50:50 mix of polyfluoroether diamine and fluoropolyether, useful for spraying on structures in an about 50:50 mix of resin:carbon dioxide, more preferably 70:30 mix of resin:carbon dioxide. It is important to control the viscosity of the mix. Such viscosity may be controlled by regulating the molecular weight and/or the concentration of the mix. Also useful in these compositions are fluorinated urethane, amorphous copolymers and fluoroalkoxylated polymers. Also disclosed is a method of using such compositions for imparting graffiti resistance to structures, such as buildings.

### DETAILED DESCRIPTION OF THE INVENTION

DSP 1501 means a resin which consists of a 50:50 mix of perfluoropolyether diamide, more preferably a 70:30 resin:carbon dioxide mix, and low molecular weight perfluoropolyether (such as Krytox®, available from E. I. du Pont de Nemours and Company, Wilmington, Del.), sprayed in an about 50:50 mix, preferably a 70:30 mix, of resin:carbon dioxide.

Also useful in these compositions are fluorinated urethane, amorphous copolymers and fluoroalkoxylated polymers and mixtures thereof.

Graffiti resistance tests were completed for DSP 1000 on Carrara marble. The Carrara marble panels treated were of dimensions about 28″ long, 6-7″ wide and ¾″ thick with DSP 1501 at nominal coverage levels of ˜7-8 gms/m2 using the supercritical CO2 sprayer. Each panel was masked lengthwise using brown paper and masking tape so that only half of each panel was treated. Higher coverage levels (estimated at >15 gms/m2) were generated at the ends of some panels. The higher coverages occurred in cases when the spray gun was initially triggered while it was pointing at the end of the panel before beginning to sweep the spray gun across the panel surface. Areas with higher coverage level were visually apparent in the laboratory after treatment because the “gloss time” in these areas was longer by more than a day when compared to the gloss time of panel midsections. These panels were marked up or “defaced” (to simulate graffiti) in the laboratory using colored “Expo” dry erase markers, “Sharpie” permanent pen markers and acrylic spray paints. At least three colors of each type of marker or paint were used. The panels were defaced in such a way that the marker or paint covered adjacent treated and untreated parts of the panel. i.e., lines from the dry erase and permanent pen markers were drawn across the panel surface so that part of the line was drawn on the treated area and part of each line was drawn on the untreated area. Paints were similarly sprayed across the panel surface so that part of the painted area covered treated area and part of the painted area covered untreated area. The paints and markers were allowed to dry for at least an hour. Some were allowed to dry overnight.

Various potential cleaners and solvents (water, soapy water, abrasive cleanser, acetone, isopropanol, dibasic ester . . . ) and various application methods (plastic squeeze bottles and droppers to apply neat solvent to the dried markers and paints; dry and saturated paper towels, absorbent cloths and q tips) were combined in different tests for each type of marker or paint in order to develop methods to clean the markers and paints from the surfaces of the marble panels. The cleaning methods were applied to the treated and untreated surfaces of the marble simultaneously. In cases where a cleaning method partly removed the marker or paint from the surface of the marble, areas of the marble that had been treated with DSP 1501 showed more complete removal of the marker or paint than did the adjacent untreated area of the marble. More complete removal of the marker or paint from the treated areas was visually evidenced by less residual color from the marker or paint in the treated area compared to the untreated area. Less residual color in treated marble was evident both in the area directly marked or painted and in the areas adjacent to the directly marked or painted area. i.e., the color from marks or paints dissolved by solvents were more likely to smear, soak into and leave a residual tint on untreated marble than on DSP 1501 treated marble. Solvents that solubilized the graffiti included acetone (dry erase markers), isopropanol (permanent pen markers) and dibasic esters (acrylic paints) Materials most successful in complete removal of color were solvents that solubilized the marker or paint but which were generally incompatible with the underlying DSP 1000. Application methods that were most successful were mechanically gentle so that the underlying DSP treatment was less disturbed by the cleaning. Soft, absorbent cloths saturated with the appropriate solvent, applied gently to the marked or painted area worked best.

Visual inspection of marked or painted marble under a lighted magnifying glass indicated that marks and paints on treated areas tended to bead up and not penetrate the stone pores or “wet” the surface of the stone as much as did marks and paints on adjacent areas of untreated marble. Less surface penetration or wetting suggests that the mechanical force provided by low pressure power washing should remove marks and paints from treated surfaces more efficiently than similar treatments applied to marks and paints on untreated surfaces. Removal of marks and paints applied to the ends of panels with higher coverages of DSP 1501 was more complete than in areas with lower coverages. i.e., cleaning procedures left less residual ghosting or tinting.

Preliminary tests of graffiti resistance on Carrara marble panels treated with DSP 1501 appear promising. I think we will be able to claim “graffiti resistance” properties for DSP 1000.

Acrylic spray paints, dry erase markers and permanent pen “Sharpie” markers were used in scouting tests. Clear, visual differences between treated and untreated marble are evident both before cleaning (the paint/markers do not wet the treated surface as well) and after cleaning the graffiti (much less or zero residual color on the cleaned treated surface) are evident. It is desirable to optimize the DSP 1000 treatment coverage (better resistance is anticipated with higher coverage) and develop recommended cleaning methods for different paints/markers. An entire building can be treated with one coverage and then the bottom can be retreated for about 15′ to get a higher coverage in the graffiti zone to improve resistance.

From a 10×30 cm aluminum target and weight changes one can get the following coverages in gms/m2.

| | | |
|---|---|---|
| | weight change | |
| Passes | DSP 1000 coverage (50%) | resin coverage |

| | | | |
|---|---|---|---|
| 2 | 1.452 | 16.13 | 8.07 |
| 2 | 1.293 | 14.37 | 7.18 |

What is claimed is:

1. A resin consisting of a 50:50 mix of polyfluoroether diamine and a compound selected from the group consisting of fluoropolyethers, fluorinated urethanes, amorphous copolymers and fluoroalkoxylated polymers, in an about 50:50 mix of said resin:carbon dioxide.

2. A resin consisting of a 50:50 mix of polyfluoroether diamine and a compound selected from the group consisting of fluoropolyethers, fluorinated urethanes, amorphous copolymers and fluoroalkoxylated polymers in an about 70:30 mix of said resin:carbon dioxide.

3. The resin:carbon dioxide mix of claim 1 or claim 2 where the viscosity of the mixture is controlled by regulating the molecular weight and/or the concentration.

4. The resin:carbon dioxide mix of claim 1 or claim 2 used as a coating on a structure for restricting graffiti build-up.
